(19) United States
(12) Patent Application Publication
(10) Pub. No.: US 2009/0050788 A1
(43) Pub. Date: Feb. 26, 2009

(54) System for Sequentially Measuring the Output of a Plurality of Light Sensors Which Generate Current in Response to Incident Light

(76) Inventor: Clint L. Deckert, Taft, CA (US)

Correspondence Address: Harold L Jackson;Jackson Law Corporation, 14751 Plaza Dr Ste N, Tustine, CA, 92780, US

(21) Appl. No.: 11/991,889

(22) PCT Filed: Sep. 12, 2006
(86) PCT No.: PCT/US06/35395

§ 371 Date: Mar. 12, 2008

(30) Foreign Application Priority Data
Sep. 13, 2005 (US) 60716597

(51) Int. Cl. G01J 1/44

(52) U.S. Cl. 250/208.3

(57) ABSTRACT

A system for sequentially measuring the current generated by a plurality of individual current sources such as photodiodes monitoring the light output of individual LEDs representing discrete colors arranged in an array of pixels constituting an area illumination source such as an electronic billboard includes (1) a current measuring circuit connected to each current source/photodiode; (2) a separate switch such as a switching diode connected in series with each current source/photodiode and (3) sequential control means for sequentially enabling each switch/switching diode to conduct current from the current source/photodiode to the current measuring circuit while maintaining all of the remaining switches in the disable state.

### RELATED APPLICATION

This application is based on and claims priority of U.S. Provisional Application No. 60/716,597 (“'597 application”) for a System for Sequentially Measuring the Output of a Plurality of Light Sensors Which Generate Current in Response to Incident Light filed on Sep. 13, 2005, the contents of the provisional application are incorporated herein by reference.

### FIELD OF THE INVENTION

This invention relates to a system for measuring the output of a plurality of current generating light sensors such as photodiodes and particularly to a system for measuring the light output of the individual LEDs which form an area illumination source, for example, of the type described in international application no. PCT/0504/12122, filed on Apr. 20, 2004 for an LED Illumination Source/display With Individual LED Brightness Monitoring Capability (“'122 application”) and the like apparatus. Further, the invention relates to an integrated photodiode/switching diode sharing a common substrate for use in such system.

### BACKGROUND OF THE INVENTION

The '122 application, the contents of which are incorporated herein by reference, describes a novel area illumination/display apparatus in which the luminous intensity of the individual LEDs forming a pixel and representing a discrete color, such as red, blue and green, can be monitored for calibration and other purposes. Two possible light measuring circuits employing photodiodes embedded within each LED or within each pixel are described in the '122 application. In one example, a light to frequency converter is embedded with each photodiode. In another example a more conventional matrix circuit is discussed in which the current generated by selected individual photodiodes is converted to a charge on a capacitor, the rate of the charge being proportional to the light absorbed by the photodoide. The rate of charge is then converted to an output signal indicative of the luminous intensity of the light emitted from the respective LED(s) and supplied via a digital to analog (D/A) converter to a digital processor.

The light to frequency converters become expensive when used with a large array of pixels. The matrix circuit performs very well with little ambient light, but may provide inaccurate readings where considerable ambient light is present because current generated by photodiodes arranged in the same column, but not coupled to the selected light source, may distort the output.

By way of background a photodiode can be thought of as a current source 10 in parallel with a diode 12, as shown in FIG. 1. The current level from the current source is proportional to the amount of received light and flows in a direction opposite the normal current flow direction of the internal diode. If a path external to the photodiode is provided for the current, the resulting voltage across the device will be in a direction to start forward biasing the internal diode. If an external path for the current is not present, this current flow will cause the forward bias to increase until the bias voltage level is sufficient to allow the current to flow through the diode.

The photodiode current can be measured in many ways, with one typical approach shown in FIG. 2 in which an operational amplifier (OPAMP) 14 with its input 16 (negative terminal 16a and positive ground or reference terminal 16b) coupled to the photodiode provides a signal on output 18. In this case the current from the photodiode will flow in the direction to cause the output signal on output 18b to increase in the positive direction, until the current flow in the feedback resistor R is equal to the photodiode current. The voltage across the photodiode is maintained near zero by the high gain of the amplifier. The output voltage of the amplifier is equal to the photocurrent multiplied by the value of the feedback resistor R, and this amplifier configuration is typically called a current-to-voltage converter, or I-V converter. A D/A converter 20 may be used to supply the output to a digital processor for further processing.

While the circuit of FIG. 2 will effectively measure the emitted luminosity output of individual LEDs it requires considerable hardware, e.g., numerous OPAMPs and D/A converters.

There is a need for simpler system for measuring the light emitted by individual LEDs arranged in a pixel array forming an area illumination source such as a display sign or billboard which provides a reliable output relatively independently of ambient light conditions.

### SUMMARY OF THE INVENTION

In a broad sense the invention is tailored to sequentially measure the current generated by a plurality of light sensors, with each sensor arranged to generate a current in accordance with the incident light received by the sensor. A current measuring circuit has an input connected to each of the sensors for receiving the current generated by the sensors and an output for providing an output signal in accordance with the input signal. A separate switch is connected in series relationship with each sensor and the measuring circuit input with each switch having an on condition for passing current therethrough and an off condition for blocking the passage of current therethrough. Sequential control means is arranged to sequentially turn each of the individual switches to the on condition while maintaining the remaining switches in the off condition, whereby the current measuring circuit will measure only the current generated in the light sensor connected in series with the switch in the on condition. The switches may be in the form of discrete semiconductor switches such as field effect transistors, analog switch integrated circuits, electromechanical relays, etc. The output of the current measuring circuit may be supplied to a digital processor via an A/D converter. Diodes, when used as switching elements, may form an integrated circuit with respective photodiodes by sharing a common substrate.

As an implementation to the self-calibrating electronic display or billboard of the '122 application, the switches may be in the form of conventional diodes, e.g., simply silicon diodes, making use of the forward and reverse bias characteristics of such diodes to sequentially connect the output of the photodiodes embedded with the individual LEDs or groups thereof to the input of the measuring circuit.

In a narrow sense the invention is directed to a system for measuring the light output of individual LEDs representing a discrete color in a pixel in which an array of such pixels form an area illumination source with a photodiode being arranged to receive a portion of the light output from each LED or each of the LEDs within each pixel representing a discrete color and produce an output current representative of the received light. The current measuring circuit, which is preferably in the form of an OPAMP, has its input connected to each photodiode. A switching or isolation diode is individually connected in series relationship with each photodiode and the current measuring circuit or OPAMP input. The sequential control means preferably comprises bias means for sequentially biasing one of the switching diodes into its on condition while biasing the remaining diodes into their off condition so that the OPAMP input receives the current generated by each photodiode in sequence. This arrangement minimizes the hardware requirements in that only one OPAMP and one A/D converter can be used with a large number of light sensors, i.e., photodiodes.

### BRIEF DESCRIPTION OF THE DRAWINGS

FIG. 1 is a schematic circuit diagram representative of a light sensor in the form of a photodiode showing the direction of the generated current;

FIG. 2 is a schematic circuit diagram of a prior art circuit approach for measuring the photodiode current;

FIG. 3 is a front view of a area illumination source in the form of an electronic video display module comprised of an array of pixels with each pixel including a plurality of LEDs;

FIG. 4 is a schematic circuit diagram showing the placement of a switching or isolation diode in series with the photodiode and the current measuring circuit of FIG. 2;

FIG. 5 is a schematic circuit diagram of a system for sequentially measuring the current generated by a plurality of light sensors in accordance with the present invention; and

FIG. 6 is a top plan view of an integrated circuit comprised of a PIN photodiode and switching diode sharing a common substrate; and

FIG. 7 is a simplified cross-sectional view of the integrated circuit of FIG. 6.

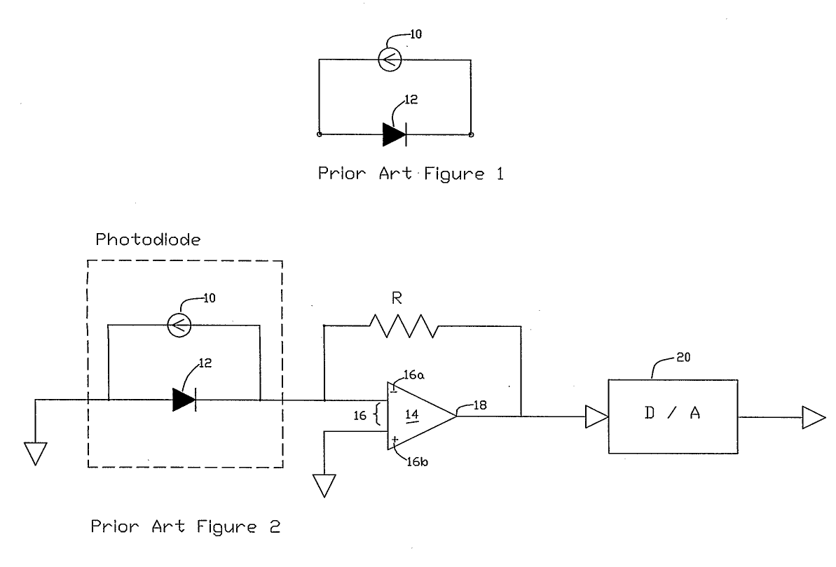

### DESCRIPTION OF THE PREFERRED EMBODIMENT

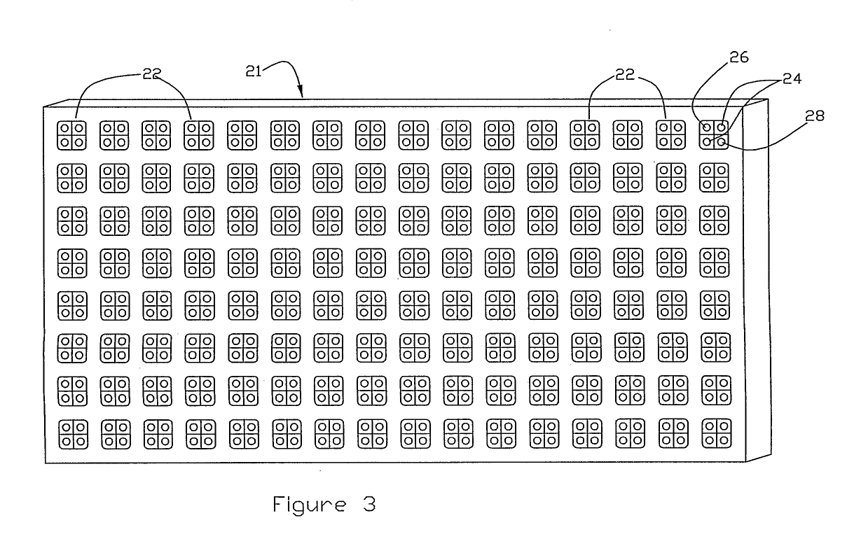

Referring now to FIG. 3 an LED video display module or array 21, as described in the '122 application, is comprised of individual pixels (picture elements) 22 with each pixel comprising two red LEDs 24, one blue LED 26 and one green LED 28 mounted on a printed circuit board. It is to be noted that the number of LEDs and the distribution of color within each pixel is not restricted to those just mentioned.

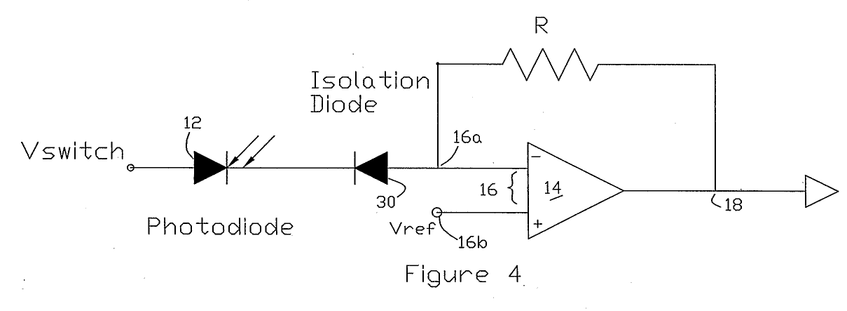

FIG. 4 illustrates the use of a switching element 30, e.g., an isolation or switching diode, connected in series with the photodiode 30 for selectively passing current generated in the photodiode to the current measuring circuit, i.e., the OPAMP/I-V converter 14, or blocking the passage of such current.

A separate photodiode (preferably a PIN photodiode) is preferably incorporated into each LED of FIG. 3 or alternatively embedded in each pixel as is illustrated in FIGS. 3 and 4 of the '122 application. An isolation or switching diode 30 is connected in series between the photodiode 12 and the input 16 of OPAMP/I-V converter 34. The isolation diode may be a separate component or formed integrally with the photodiode on a common substrate.

As noted in reference to FIG. 2, a conventional feedback resistor R is connected between the output terminal 18 and input terminal or summing node 16a. The operation of the circuit of FIG. 4 may be illustrated by biasing the positive input terminal 16a of the amplifier (marked Vref) slightly above ground, say +2 volts and connecting the anode of the photodiode to a higher positive source (v switch), say +3.3V. The isolation diode 30, between the I-V converter 14 negative input terminal 16a and the photodiode cathode, will then be reverse biased, preventing any current flow into the I-V converter, effectively disconnecting the photodiode. As discussed before, any photocurrent will now forward bias the internal diode in the photodiode, causing the cathode of the photodiode to be a diode drop (e.g., 0.6V) lower than the anode. The cathode of the photodiode will be at 2.7V, maintaining the reverse bias across the isolation diode.

If the anode of the photodiode (terminal marked v switch), is now connected to ground, the isolation diode will be forward biased, allowing the photodiode current to flow into the I-V converter with the converter output voltage level increasing until the current through the feedback resistor is equal to the photdiode current.

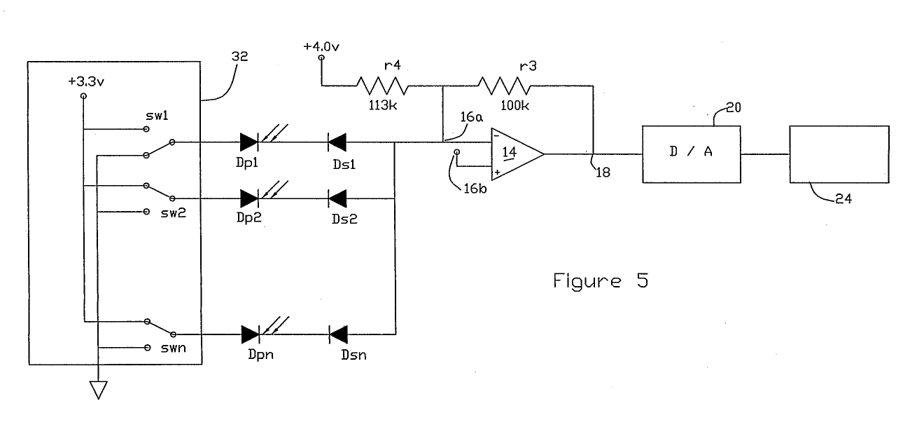

A sequential control module, e.g., in the form of a shift register 32 with appropriate bias voltages is shown in FIG. 5. The sequential control module sequentially biases one of the isolation diodes on while maintaining all of the remaining diodes off so that the I-V converter amplifier measures only the current generated by the photodiode connected in series with the isolation diode biased in the on condition.

Specifically, the anode of the selected photodiode diode, e.g., Dp₁, is switched to ground by the shift register in this example (as represented by switching element Sw₁), for the period of the measurement. The shift register is loaded with a binary sequence that will have all the outputs in the high state except for the one output connected to the photodiode selected for measurement. Since the input of the I-V converter amplifier summing node 16a is at +2.0V, the isolation diode Ds₁ is now forward biased, allowing the photocurrent from the photodiode Dp₁ to flow into the I-V converter summing node.

The other photodiodes, Dp₂-Dpn, have their anodes switched to a +3.3V source from the shift register 22 via switching elements Sw₂ and Swn. This reverse biases the isolation or switching diodes Ds2-Dsn disconnecting the I-V converter summing node from photocurrent flowing in photodiodes Dp₂ through Dpn.

After the A/D converter 20 has completed the conversion and sent the result to a digital processor or microcontroller 24, the shift register is loaded with a different binary sequence that will select the next photodiode for measurement.

The 4.0V bias voltage connection to the R4 resistor (113 KΩ) and the 100 KΩ resistor R3, sets the I-V converter amplifier output near ground without any photodiode current. While the number (n) of photodiodes connected to a single current measuring circuit may vary, I have found that one current measuring circuit, e.g., OPAMP 14 and related components of FIG. 5, will readily handle the current measurements from 48 photodiodes.

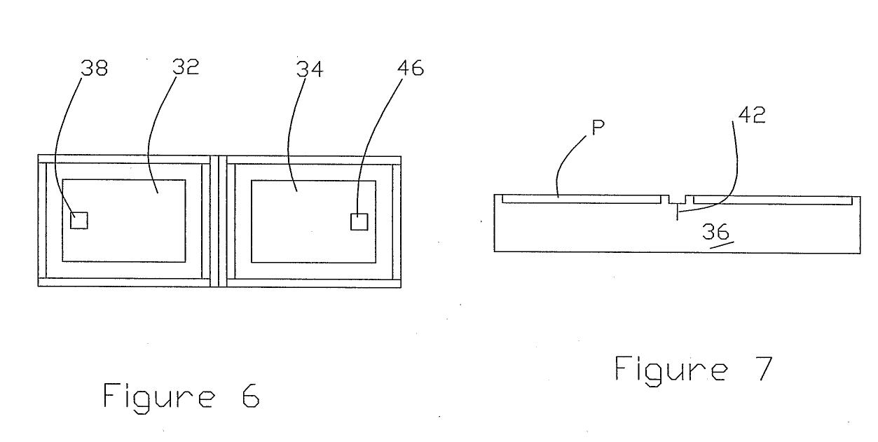

Referring now to FIGS. 6 and 7 a PIN photodiode 32 and isolation diode 34 are formed as an integrated circuit sharing a common substrate 36. Bond wire contacts 38 and 40 allow the series connected photodiode and isolation diode to be connected between the current measuring circuit and the sequential control module. The substrate, e.g., silicon, forms the conduction path between the active elements in a conventional manner. The silicon may be cut along line 42 to inhibit leakage current between the elements. Actual sizes of the elements are illustrated in the figures.

It is to be noted that the above bias voltage levels used as examples only. Also the polarity of the photodiodes and isolation diodes can be reversed with appropriate changes in the bias voltages and the isolation diode can be placed on either side of the photodiode.

The disclosed system results in a method to simply, and inexpensively, sequentially switch the input of a current measuring circuit to a group of photodetectors. The current measuring circuit will respond to only the selected photodetector, totally ignoring the remaining photodetectors. The system may have broader applications, i.e., sequentially measuring the current from a plurality of current sources.

What is claimed is:

1. A system for sequentially measuring the current generated by a plurality of light sensors, with each sensor arranged to generate a current in accordance with the incident light received by the sensor comprising:
a) a current measuring circuit having an input connected to each of the sensors for receiving the current generated by the sensors and an output for providing an output signal in accordance with the input current;
b) a separate switch connected in series relationship with each sensor and the input to the current measuring circuit with each switch having an on condition for passing current therethrough and an off condition for blocking current therethrough; and
c) sequential control means for sequentially turning each of the switches to the on condition while maintaining the remaining switches in the off condition, whereby the current measuring circuit will measure only the current generated in the light sensor connected in series with the switch in the on condition.

2. The system of claim 1 wherein each of the light sensors comprises a photodiode and wherein each of the switches comprises a diode.

3. The system of claim 2 wherein the current measuring circuit comprises a current to voltage converter including an operational amplifier.

4. The system of claim 3 wherein the sequential control means is arranged to control the bias voltages to the switching diodes.

5. A system for measuring the light output of individual LEDs representing a discrete color in a pixel in which an array of such pixels form an area illumination source and a photodiode is arranged to receive a portion of the light output from each LED(s) within each pixel representing a discrete color and produce an output current representative of the emitted light comprising:
a) a current measuring circuit connected to each photodiode for receiving the output current therefrom;
b) a switching diode connected in series relationship with each photodiode and the current measuring circuit; and
c) sequential control means for sequentially turning on each switching diode to conduct the current from a respective photodiode to the current measuring circuit while maintaining all of the other switching diodes off so that the current measuring circuit will measure only the current generated in the photo diode connected in series with the conducting diode.

6. The system of claim 5 wherein the switching diodes are connected between the photo diodes and the current measuring circuit.

7. The system of claim 6 wherein the current measuring circuit comprises an OPAMP with its input connected to each of the switching diodes and wherein the sequential control means applies one bias voltage to render one of the switching diodes conducting and another bias voltage to maintain the remaining switching diodes nonconducting.

8. A system for sequentially measuring the current from a plurality of individual current sources comprising:
a) a current measuring circuit having an input connected to each of the current sources for receiving the current produced by the sources and an output for providing an output signal in accordance with the input current;
b) a separate switch connected in series with each current source and the measuring circuit input, each switch having an on condition for passing current therethrough and an off condition for blocking the passage of current therethrough, and
c) sequential control means for sequentially turning each switch on while maintaining the remaining switches in the off condition whereby the current measuring circuit will measure only the current from the current source connected in series with the on condition switch.

9. The system of claim 8 wherein the switch is a diode.

10. A photodiode and switching diode formed as an integrated circuit with the photodiode and switching diode sharing a common substrate.
